(19) United States
(12) Patent Application Publication
(10) Pub. No.: US 2026/0292944 A1
(43) Pub. Date: Sep. 24, 2026

(54) Fluid Heating System

(71) Applicant: Technische Universiteit Eindhoven, Eindhoven (NL)

(72) Inventors: Muhammed Samir Abdallah, Eindhoven (NL); Philip De Goey, Eindhoven (NL); Giulia Finotello, Eindhoven (NL); Yuriy Shoshyn, Eindhoven (NL)

(21) Appl. No.: 19/475,872

(22) PCT Filed: Apr. 18, 2024
(86) PCT No.: PCT/NL2024/050201

§ 371 Date: Oct. 16, 2025

(30) Foreign Application Priority Data
Apr. 21, 2023 (NL) 2034660

(51) Int. Cl. H05B 6/10; F23G 7/00; F23L 15/00

(52) U.S. Cl. CPC H05B 6/108; F23G 7/00; F23L 15/00; F23G 2204/204

(57) ABSTRACT

The present disclosure relates to a fluid heating system. The fluid heating system includes a fluid conduit having an inflow end and an outflow end for a flow of fluid to be conducted therethrough. Further, the fluid heating system includes an inductive heater arranged in the fluid conduit, wherein the flow of fluid passes the inductive heater of which a temperature rises, when subjected to an electromagnetic field. Also, the fluid heating system includes an electromagnetic field generator to generate, when activated, the electromagnetic field and thereby induce a rise in temperature of the inductive heater. The inductive heater may comprise a plurality of discrete inductive heating elements. The present disclosure also relates to an ignition system, including the aforementioned fluid heating system and a medium supply.

### CROSS-REFERENCE TO RELATED APPLICATIONS

This application is the United States national phase of International Patent Application No. PCT/NL2024/050201 filed Apr. 18, 2024, and claims priority to The Netherlands Patent Application No. 2034660 filed Apr. 21, 2023, the disclosures of each of which are hereby incorporated by reference in their entireties.

### BACKGROUND

### Technical Field

The present disclosure relates to a fluid heating system, comprising a fluid conduit having an inflow end and an outflow end for a flow of fluid to be conducted therethrough. The fluid heating system further comprises an electromagnetic field generator and an inductive heater. The inductive heater is arranged in the fluid conduit, wherein the flow of fluid passes the inductive heater of which a temperature rises, when subjected to the electromagnetic field. The present disclosure also relates to an ignition system, comprising the aforementioned fluid heating system and a medium supply.

### Technical Considerations

Electric heating systems in general are applicable in very diverse fields and scales of industry, and most of the existing examples are based on resistive heating.

There is a continuous need for providing more efficient heating of fluid flows to increasingly smaller and more strictly defined temperature ranges, required for heating fluid flows that may have very differing flow rates or speeds.

Although there are several types and configurations of resistive heaters, these are inherently quite inaccurate with respect to realising a temperature of an outgoing fluid flow, where regular problems with implementation thereof are aggravated by exponentially increasing power consumption at higher desired temperatures and a dependency of resulting realized temperatures on unknown flow rates or speeds and unpredictable variations therein. Certain resistive heating systems rely on a resistive coil of e.g. Nichrome to heat the fluid flow. However, then heat transfer to this fluid flow is by definition limited by the heating area (surface) of the solid resistive heating coil. To achieve higher temperatures, a bigger coil and/or windings thereof is required to increase an effective heat exchange surface, which contributes to an undesirable increase in size of resistive heating systems, and a big size allows heat loss from a heated fluid flow before being expelled from an outflow end, and as a consequence upscaling size increases potential for heating which is at the same time diminished by sheer size, and realizing desired high temperature becomes a matter overdesigning according to a brute force approach, detrimentally contributing to energy consumption and required space. Besides, certain resistive heaters are also limited to a quite low convection heat transfer coefficient.

Recent developments are moving in the direction of inductive heating of a fluid flow, providing some modest improvement over resistive heating, but there is still considerable room for improvement, e.g. in terms increasing output temperatures, while lowering power consumption as well as reducing size of fluid heating systems, relative to existing resistive heating systems.

In CN-212902013U, steel finned tubes are arranged in parallel and are heated inductively by coils wound around the tubes. When current is made to flow through the coils, the associated steel finned tubes are heated and—using a fan—fluid is made to flow through spaces in between the parallel steel finned tubes, so as to heat the fluid. This is rather inefficient.

CN-217057953U discloses a tubular heat exchange device having a plurality of straight small (incorrectly identified as porous) air ducts running in parallel through a tubular block of material that is heated when a coil around the block is energized, while a fan draws or thrusts a flow of fluid through the air ducts. This disclosure constitutes a modest improvement over CN-212902013 in terms of contact area (m²) for heat transfer to the fluid per volume (m³).

CN-213747303U discloses a tubular foam metal body in a copper ring (or tube) and a cable wound around the surface of the copper ring (or tube) to form a coil for generating—when energized by passing an electric current therethrough—an electromagnetic field. The metal foam is more truly porous in the technical sense of this expression (than CN-217057953U), resulting is a further increased ratio of contact area (m²) to volume (m³). The foam metal at least contains (or even consists of) iron, nickel and/or cobalt to heat up in the generated (electro) magnetic field, and fluid flowing through the metal foam is heated. When it is desired to increase temperatures of fluid flowing out of the metal foam with the coil energized, one logical way of addressing such a desire is to increase a length of the foam metal body. However, this would result in potential congestion of the fluid flow in the foam metal and an associated decrease in an achievable flow rate, as well as an undesired increase in size of a resulting configuration. Als an alternative means to address such a desire, it's possible to increase a strength of the field generated by the coil at the detrimental cost of an exponential increase in power consumption.

CN114933281 is from a remote technical field pertaining to a natural gas steam reforming furnace with induction heating, where the induction heating is—in and of itself—comparable with that according to CN-213747303U, but wherein a catalyst is loaded into foam metal forming a carrier for the catalyst. The disclosure relates to hydrogen production from new energy and natural gas. The catalyst in the foam metal comprises spherical direct reduced iron to reform coke oven gas. Modifying this device to omit the catalyst would render it inoperable for the purpose envisaged in this publication.

Based on the foregoing summary, inductive heating has the potential of exhibiting an advantage that a heat exchange surface can be increased quite dramatically over resistive systems, for example by deploying a heating element of porous or sponge-like design for the fluid flow to pass therethrough, while an external electromagnetic field generator is used to apply a field to which parts or the whole of the heating element responds with increasing the temperature thereof, and with the large heat transfer area thereof for the fluid flow, an improved efficiency of heat transfer may be achieved relative to resistive heating system.

A porous or foam-like or similar heating element also inherently may exhibit a property of restricting flow rate or speed for passing a fluid flow, more than a resistive coil. If such a heating element is made longer in a flow direction of the fluid to achieve an outbound flow at a higher temperature, the porous or foam-like or similar heating elements also forms somewhat of a flow (rate) obstacle, at the expense of a markedly lower value of an outbound volume per time unit of a heated fluid flow.

### SUMMARY

The fluid heating system including an inductive heater according to the present disclosure provides a number of improvements. A heater according to the present disclosure incudes a plurality of discrete inductive heating elements arranged in a fluid conduit. The heating element may form an array or stack in the flow direction, which flow direction may be horizontal or vertical. Depending on a desired output in terms of at least a reached temperature and/or flow (rate) obstruction, heating elements may be added to or omitted. Thus, a shorter or longer array or a lower or higher stack may be formed, dependent on requirements in terms of outbound flow and achieved temperature. This allows designers and users more design freedom to achieve the desired temperature and outbound flow by adding/removing elements in/from the conduit, as desired. The present disclosure moreover provides a fluid heating system having an inductive heater with which an improved homogeneity of the flow distribution of a fluid through heating elements and beyond the outflow are realized. Furthermore, the present disclosure provides a fluid heating system with an improved homogeneity of the temperature distribution in such and/or through the heating elements and beyond the outflow of the conduit.

The present disclosure proposes a fluid heating system with a heater with enhanced heating/contact area and heat transfer coefficient, while keeping the size of the configuration, and in particular a dimension thereof in the direction of the fluid flow through the conduit, limited in correspondence to a desired outbound flow and temperature thereof, by enabling a purposeful and corresponding selection and arrangement of a pre-determined or in practice determined number of the discrete inductive heating elements (and preferably no more), while at the same time taking account of a combined obstruction of the fluid flow and being able to adjust the same also by the selection of an appropriate number of the discrete inductive heating elements.

In a potential embodiment the fluid heating system of this disclosure may exhibit the feature that at least one of the plurality of inductive heating elements is permeable to the flow of fluid to allow the flow of fluid to pass through the interior thereof. In such a potential embodiment the at least one of the plurality of inductive heating elements may be of a or include a structure from a group comprising: a porous material, a perforated material, a mesh, a wool, a sponge, and/or a foam, such as a metal foam.

In a potential additional or alternative embodiment, the fluid heating system of this disclosure may exhibit the feature that the plurality of discrete inductive heating elements comprise at least one metal from a group, comprising: cobalt, iron, and nickel.

In a potential additional or alternative embodiment, the fluid heating system of this disclosure may exhibit the feature that the heating elements are arranged one after the other in the flow direction of the flow of fluid.

In a potential additional or alternative embodiment, the fluid heating system of this disclosure may exhibit the feature that at least one pair of immediately adjacent discrete inductive heating elements are arranged at a distance therebetween. In this embodiment, at least two of the discrete inductive heating elements have a distance between them defining a space between the heating elements. Thereby, an enhanced heat transfer area and improved heat transfer coefficient may be realized, together with a more uniform temperature distribution in the outbound fluid flow and a more uniform velocity distribution across the heating elements, as well as more flexible design or assembly options. One or more spacings between heating elements provides the advantage of creating homogenizing zones between the heating zones defined by the heating elements. The spaces may be dimensioned so that convection and radiation contribute to heating the fluid in the flow in addition to contact heating, while the dimension of assembled/stacked heating elements with at least one such space or distance therein may turn out to be shorter than in a configuration with abutting elements in the stack.

Such an embodiment may further comprise at least one spacer arranged between the immediately adjacent heating elements. Additionally or alternatively the fluid heating system may further comprise at least one support configured to hold at least one of the heating elements in the conduit.

In a potential additional or alternative embodiment, the fluid heating system of this disclosure may exhibit the feature that at least one of the plurality of inductive heating elements comprises a carrier, wherein heating material, susceptible to heating when subjected to the electromagnetic field, is dispersed therein. In such an embodiment, the carrier may be of a or include a structure from a group comprising: a porous material, a perforated material, a mesh, a wool, a sponge, and/or a foam.

In a potential additional or alternative embodiment, the fluid heating system of this disclosure may exhibit the feature that at least one heating element is disposed within the conduit such that an outer periphery of the heating element is in close proximity to an inner wall of the conduit. In such an embodiment, a plurality of heating elements may disposed within the conduit such that outer peripheries of the plurality of heating element are in close proximity to an inner wall of the conduit. Thereby more of the fluid to be heated is compelled to pass through the one or more or all of the heating elements.

In a potential additional or alternative embodiment, the fluid heating system of this disclosure preferably exhibit the feature that the field generator is arranged outside of the conduit. However, it may also be arranged inside the conduit.

In a potential additional or alternative embodiment, the fluid heating system of this disclosure may exhibit the feature that the conduit comprises a thermal insulation. This allows for concentration of generated heat in the fluid flow for optimal heating thereof, and—maybe even more pertinent—may shield and protect the electromagnetic field generator, which may consequently be embodied as simply as a metal, possible copper, wire (optionally with suitable insulation) helically wound around the conduit.

In a potential additional or alternative embodiment, the fluid heating system of this disclosure may exhibit the feature that the conduit comprises a ceramic material, such as quartz.

In a potential additional or alternative embodiment, the fluid heating system of this disclosure may exhibit the feature that the field generator comprises at least one field coil connected to an AC source.

In a potential additional or alternative embodiment, the fluid heating system of this disclosure may exhibit the feature that the field generator comprises a plurality of field coils connected to the AC source. In such an embodiment, the AC source may comprise a plurality of coordinated or cooperating AC supplies.

In a potential additional or alternative embodiment, the fluid heating system of this disclosure may exhibit the feature of an upright, horizontal or angled (oblique) stand extending at least partially through the fluid conduit to the outflow end of the fluid conduit. In such an embodiment, at least one of the plurality of discrete inductive heating elements has an opening extending therethrough, and the stand is accommodated therein. Such a stand need not be vertical and could be horizontal, or at an angle or oblique. The feature of a horizontal, vertical or angled stand allows for positioning, e.g., centering, some or preferably all of the discrete inductive heating elements in the fluid conduit.

When unheated, these inductive heating elements should not contact the inner wall of the fluid conduit. When heated or heating, the inductive heating elements may expand and then still, it would be preferable to ensure that these do not contact the fluid conduit, to avoid inside-out pressure on the fluid conduit as well as abrupt temperature variations along the length of the fluid conduit. In particular if the fluid conduit is of alumina or even quartz, which is a brittle material, inside-out pressure and/or abrupt temperature variations along the length thereof may be detrimental for the fluid conduit in the short or longer term; the fluid conduit may crack or burst when inside-out pressure or temperature variations along the length thereof exceed robustness or resistance properties of the material of the fluid conduit. However, also preferably, at the same time, the heating elements are dimensioned and arranged such, that their periphery is close to the inner wall of the fluid conduit, otherwise referred to the heater housing/conduit, in order to force as much as possible of an air flow carrying the ignitable particles or other media through the heating elements.

Further, the present disclosure relates to an ignition system, such as a particle ignition system, comprising the fluid heating system, as disclosed herein above, and a medium supply, such as a particle supply. Examples of media to be ignited may include metal, oil, wax and/or another organic and/or inorganic material.

In an embodiment of the ignition system based on a fluid heating system according to any embodiment of the disclosure, the fluid heating system may further include a medium delivery assembly comprising a medium delivery channel extending at least partially through the fluid conduit to debouch at or near the outflow end of the fluid conduit. An exemplary medium delivery assembly has an inlet and an outlet connected to the inlet by the medium delivery channel, the inlet being in fluid communication with the medium generator. In an exemplary embodiment, the medium delivery channel comprises a medium delivery tube.

In an embodiment of the ignition system, based on a fluid heating system with a stand, the stand may comprise a medium delivery tube extending at least partially through the fluid conduit to debouch at or near the outflow end of the fluid conduit.

The particle supply may comprise a particle generator, wherein the medium delivery tube has an inlet and an outlet, the inlet being in fluid communication with the particle generator.

### BRIEF DESCRIPTION OF THE DRAWINGS

In the appended drawing, embodiments of fluid heating systems and components thereof are shown in non-limiting embodiments, wherein:

FIG. 1 exhibits a schematic configuration of a potential embodiment of a fluid heating system according to the present disclosure, comprising numerous, if not all, aspects of the present disclosure;

FIG. 2 exhibits a top view of one of the discrete inductive heating elements in FIG. 1;

FIG. 3 exhibits a perspective and schematic view of one of the discrete inductive heating elements in FIG. 1;

FIG. 4 exhibits temperature profiles at the center of the outbound flow, and at two distances in the X-dimension from the center; and

FIG. 5 exhibits Schlieren imaging of the temperature homogeneity of fluid in an outbound flow of air as an embodiment of fluid, wherein the an original color Schlieren imaging was converted first into a black-and-white image, and subsequently inverted into a photo-negative representation for clarity and ease of reproduction.

FIG. 6 exhibits temperature profiles at the center of the outbound flow, and at several distances in the X-dimension or a radial distance from the center of the outflow.

### DESCRIPTION

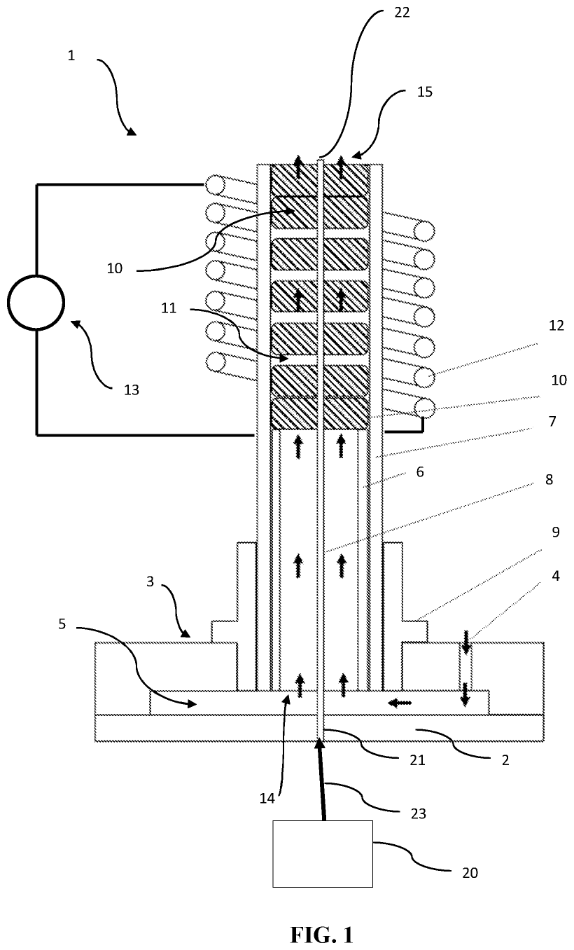

In FIG. 1, one potential embodiment of a fluid heating system 1 is shown according to the present disclosure, comprising numerous, if not all, aspects of the present disclosure. All features are described herein below in a positive sense, as being present in the shown embodiment. However, this does not necessarily mean that all shown and below described features are essential for every optional aspect in terms of features of the embodiment of the shown fluid heating system 1.

The fluid heating system 1 in FIG. 1 comprises a fluid conduit in the form of a conduit tube 7, which may be a ceramic or alumina and more specifically a quartz conduit tube, having an inflow end 14 and an outflow end 15 for a flow of fluid to be conducted therethrough. Conduit tube 7 may be any suitable shape and size. For example, it may have a circular, square, or rectangular cross section. In some embodiments, a non-tubular conduit 7 may be utilized. The fluid flow is schematically designated by arrows in bold. The flow of fluid, for example a flow of air, is introduced into the fluid heating system 1 via inlet 4, which debouches in a chamber 5, which in this embodiment is disc-shaped, between base 2 and support 3, from which chamber 5 flow of fluid is promoted into the inflow end 14 of the conduit tube 7. Support 3 is circumferentially arranged on base 2, with centrally a space there-between to define chamber 5, and at least one inlet 4 extends through support 3 from the exterior to chamber 5.

Alternatively, inlets 4 could extend through base 2, and then chamber 5 could have a cross sectional dimension much smaller than in the shown embodiment, since the flow of fluid would then not need to cross a radial distance from inlets 4 to inflow end 14.

Conduit tube 7 is connected to support 3, for example, via lock fitting 9. Support 6 extends within the conduit tube 7 from base 2 up to a position, where discrete inductive heating elements 10 need to be positioned to be arranged optimally within an electromagnetic field. Support 6 may be or comprise a cylindrical tube made of quartz or another suitable material. Additionally, a central tube 8, which may be a capillary tube made, for example, from aluminum (to form, when heated: alumina), may extend from base 2 centrally into and at least part of the way through the conduit tube 7. Tube 8 is designed to acts as a stand or support for positioning or even centring heating elements 10. For minimizing contact between heating elements 10 and conduit tube 7 and for thus centring heating elements 10 to minimize heating thereby of conduit tube 7, tube 8 may be solid or massive. Tube 8 may alternatively be embodied as a cylindrical tube, i.e. comprising a channel or conduit of its own, for instance to supply a stream of particles to be ignited at or beyond outflow end 15 of conduit tube 7, in the heated fluid flow debouching from outflow end 15 of conduit tube 7. Although, in the illustrated embodiment, tube or stand 8 is located in the centre of conduit 7, in other embodiments, it may be disposed at another suitable location within conduit 7. In this respect, ‘suitable’ refers to any position of tube 8 at which a desired arrangement or positioning of discrete inductive heating elements 10 can be achieved.

Namely, the present disclosure relates also to an ignition system, such as a particle ignition system, comprising the above fluid heating system 1 and a medium supply, such as a particle supply which may be or comprise a particle or other media generator 20 in FIG. 1. The tube 8 can then be hollow or cylindrical to form an embodiment of a medium delivery tube to carry media to be heated with particles or other medium/media to be ignited along arrow 23 to a media inlet 21 of stand 8, and subsequently through the fluid heating system 1 according to the present disclosure to outlet 22, which should coincide with or be near to outflow end of conduit tube 7, for ensuring proper ignition of particles or other medium/media at or beyond the outflow 15 and outlet 22. In one implementation, particularly suitable for igniting particles supplied by a particle generator 20, particle-carrying medium travels through the hollow or channelled stand or tube 8, entering through its inlet 21 and exiting through its outlet 22. The inlet 21 of such an exemplary medium delivery tube embodying stand 8 is in fluid communication with the particle generator 20. Alternatively, stand 8 and a media delivery tube carrying particles to be ignited may be furnished separately.

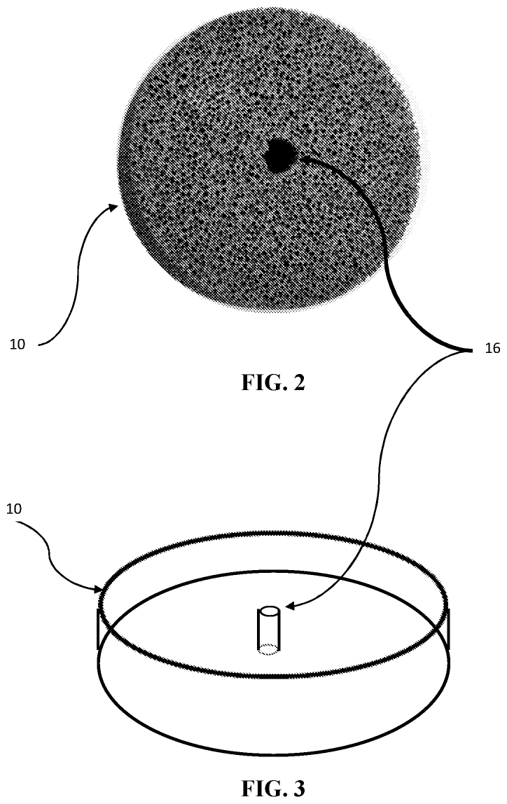

Tube 8 can be made from any suitable material that preferably can resist high temperatures. Tube 8 may be any suitable shape and size. For example, it may have a circular, square, or rectangular cross section. In some embodiments, tube 8 may be a conduit having a non-tubular shape. In yet other exemplary embodiments, the tube 8 may be omitted. Tube 8 and conduit tube 7 can be used to ensure alignment of discrete inductive heating elements 10, which may be disc shaped and are provided with an opening therethrough, such as a central hole 16, as is shown in FIG. 2 and FIG. 3, for example, for accommodating tube 8 to extend there through. The central hole 16 may have any suitable shape and dimensions. In the exemplary embodiments that include a tube 8, the shape and size of the central hole 16 matches the shape and size of the tube 8, taking thermal expansion into account. In other exemplary embodiments, one, a plurality of, or all discrete inductive heating elements 10 do not include a central hole 16. Although, in the illustrated embodiment, the one or more holes 16 are illustrated as located in the centre of the one or more discrete inductive heating elements 10, in other embodiments, the one or more holes 16 may be provided at another suitable location.

An exemplary inductive heater in the form of a plurality of discrete inductive heating elements 10 is arranged in the conduit tube 7. The flow of fluid passes along the plurality of discrete inductive heating elements 10 in a sequence, since the discrete inductive heating elements 10 are stacked in the direction of the fluid flow, indicated by the bold arrows in FIG. 1. A temperature of the discrete inductive heating elements 10 rises, when subjected to an electromagnetic field.

The inductive heating elements 10 (e.g., disks) are preferably made mainly of nickel, which has good magnetic permeability, but, in general, any material having good magnetic permeability can be used to form the heating elements 10, or be arranged therein, such as cobalt and iron. Therefore, when these elements 10 are placed inside the induction coil 12 and thus in the field generated thereby, they are heated assuming that the induction coil 12 is activated (a current flows therein).

It is noted here that although the field is herein referred to as electromagnetic, especially the magnetic component (H) thereof is responsible for heating iron, nickel and/or cobalt. On the other hand, so as not to exclude other material, that could in the future be discovered to exhibit heating properties in a mainly or purely electric field (component), the present disclosure allows for the generic indication of an ‘electromagnetic field generator’.

In the exemplary embodiments where the majority of Aluminium is in the outer surface, and when the discrete inductive heating elements 10 (e.g., disks) are heated in air, these oxidize to form an Alumina layer which protects the inner parts from further oxidation.

The discrete inductive heating elements 10 (e.g., disks) can be manufactured from 10 mm thickness sheet. As long as these discrete inductive heating elements 10 (e.g., disks) should fit inside the co-flow conduit tube 7, the size and shape (e.g., diameter) of the elements was made to match with the inner size and shape (e.g., diameter) of conduit tube 7, taking into account the thermal expansion tolerance for discrete inductive heating elements 10 (e.g., disks). Preferably, one or more or all of the heating elements 10 are placed within the conduit such that the outer periphery of the one or more or all of the heating elements 10 is in close proximity to the inner wall of the conduit. An advantage of this configuration is that more of the fluid to be heated is compelled to pass through the one or more or all of the heating elements.

In experiments, the diameter of the discrete inductive heating elements 10 (e.g., disks) was 34 mm which is a sufficient to sustain an isothermal heated region for four cm downstream the inductive heater required for iron combustion and below explained experiments as well as results thereof. For confidential experiments, the inventors used circular disks, however, any shape can be manufactured from this sheet to fit non-circular (e.g., square or rectangular) conduit or duct applications.

To this end, an electromagnetic field generator is provided, which, in this exemplary embodiment, is in the form of induction field coil 12, connected to an AC power source 13, to generate, when activated, the electromagnetic field and thereby induce a rise in temperature of the discrete inductive heating elements 10.

By heat transfer from discrete inductive heating elements 10, the fluid flow is heated and the temperature thereof is elevated.

In the shown embodiment of fluid heating system 1, the distinct, discrete inductive heating elements 10 are essentially identical, but alternatively discrete inductive heating elements 10 could exhibit distinguishing aspects, for example in terms of permeability or concentration of heat generating metals for generating heat when subjected to the electromagnetic field. In some embodiments, the fluid heating system 1 includes discrete inductive heating elements 10 having different dimensions, such as different thicknesses.

Namely, discrete inductive heating elements 10 are permeable to the flow of fluid to allow fluid to pass through the interior thereof. This allows for a high ratio of heat transferring contact surface to volume. The inductive heating elements 10 are preferably prepared from a metal foam, but may be made of or include a structure from a group comprising: a porous material, a perforated material, a mesh, a wool, a sponge, and/or a foam. The permeability thereof in different flows of different fluids may be designed at or before production of these discrete inductive heating elements 10, to select a most appropriate set before actually heating a flow of fluid.

Further, in fluid heating system 1, the plurality of discrete inductive heating elements 10 preferably comprise at least one metal from a group, comprising: cobalt, iron, and nickel. These materials (and potentially also others) heat up in an electromagnetic field, and can be processed into a metal foam with high fluid flow permeability.

In the shown fluid heating system 1, the heating elements 10 are arranged (preferably: stacked) one after the other in the flow direction of the flow of fluid. Consequently, successive heating elements 10 contribute to further heating of the flow of fluid. The lowermost of the discrete inductive heating elements 10 rests on a support 6, such as an alumina capillary tube.

A plurality, and in some embodiments, several pairs, of immediately adjacent discrete inductive heating elements 10 are arranged at a distance therebetween. These immediately adjacent discrete inductive heating elements 10 can be held and positioned at a distance from one another by using a spacer or support. In a vertical stack of discrete inductive heating elements 10, a spacer (similar to capillary tube 6) can be arranged between the immediately adjacent heating elements to maintain a distance there between. A support can also be fixed to an inner wall of conduit tube 7, and be configured to hold at least one of the heating elements 10 in the conduit tube 7.

Along this distance between immediately adjacent discrete inductive heating elements 10, space 11 is defined between the heating elements 10. Thereby, an enhanced heat transfer area and improved heat transfer coefficient may be realized, together with a more uniform temperature distribution in the outbound fluid flow and a more uniform velocity distribution across the heating elements, as well as more flexible design or assembly options. The distances between some of the inductive heating elements 10 (spaces 11 there between) may be dimensioned so that convection and radiation contribute to heating the fluid in the flow in addition to contact heating, while the dimension of assembled/stacked heating elements with at least one such space 11 or distance therein may turn out to be shorter than in a configuration with abutting elements in the stack or array. Also, such spaces 11 contribute to achieving a more uniform (in terms of temperature and turbulence) flow of fluid from the outflow of the fluid conduit.

At least one of the plurality of inductive heating elements 10 comprises, in a particular embodiment, a carrier that may in itself be unresponsive or impervious to the electromagnetic field. The heating material, that is susceptible to heating when subjected to the electromagnetic field, may be dispersed therein. In such an embodiment, the carrier may comprise a structure from a group comprising: a porous material, a perforated material, a mesh, a wool, a sponge, and/or a foam

Field generator, for example, in the form of induction coil 12, can be arranged outside of the conduit tube 7, and can be consequently protected from heat from within tube 7, especially if the conduit tube 7 is made of or includes a ceramic material, such as alumna, and more in particular quartz, which exhibits insulating properties. This allows for a relatively simple embodiment of induction coil 12, for example in the form of a copper wire, with suitable insulation, wound around an outer surface of conduit tube 7. In such an embodiment, conduit tube 7 forms a thermal insulation. This allows for concentration of generated heat in the fluid flow for optimal heating thereof, and—maybe even more pertinent—may shield and protect the electromagnetic field generator, which may consequently be embodied as simply as a metal, possibly copper, wire (optionally with suitable insulation) helically wound around the conduit.

In the foregoing description of the embodiment in FIG. 1, conduit tube 7 made of quartz is exemplified, but may alternatively be made from other materials, even if the heat insulating characteristics thereof are less than those of quartz. Ceramics may perform as well as quartz, at least in this respect.

The field generator could be formed in another embodiment than comprising at least one induction field coil 12 connected to an AC source. Also, a plurality of field coils may connected to an AC source, which may then comprise a plurality of coordinated or cooperating AC supplies 13. This is a distinguishing feature over all of the above publications, and may also distinguish the present disclosure.

Several experiments were conducted to prove the working principle of the fluid heating system according to the present disclosure. These experiments were aimed at heating up air to a temperature of (at least) 800° C. To this end, a set of seven discrete inductive heating elements 10 was used. Each heating element 10 had a ten mm thickness and a 34 mm diameter. The heating elements were composed of three elements Nickel, Chromium, and Aluminium with the followings percentages: 65%, 20%, and 12%, respectively. The porosity of the foam was set to 92.1% with average pore size of 0.6 mm. This configuration provides heat transfer area to volume ratio of 2800 m²/m³, which facilitates the compactness of the fluid heating system 1.

As shown in FIG. 1, the first heating elements 10 on or above the tube 6 and the uppermost heating elements were placed adjacent to (in contact with) each other to homogenize the velocity profile of the fluid flow through the heating elements. The intermediate heating elements 10 were spaced at a distance of 5 mm. By providing spaces in the distances between the heating elements, optical access is provided to monitor heating elements 10 to avoid overheating of the porous material thereof. In addition, these spacings help redistribute the generated heat uniformly within the fluid.

In this experiment a temperature of 800° C. was reached and even exceeded, since with this configuration temperatures of 1100° C. proved to be attainable. It is anticipated that even higher temperatures may be achieved, using suitable materials, for example carriers with one of the magnetically heating metals dispersed therein, so that higher temperatures can also be achieved, when porous material with higher working temperatures are used.

For some theoretical substantiation of the principles underlying the novel and inventive heating system 1 according to the present disclosure, the following is noted here:

Details of the fluid heating system 1 are shown in FIG. 1 and described to some extent already herein above. FIG. 1 shows the induction coil 12 to include seven turns. All of the illustrated seven discrete inductive heating elements 10 are arranged within the length of the induction field coil 12. While metal porous discs are used as the discrete inductive heating elements 10 in this example, porous elements having other shapes can be used for other applications. For example, porous elements having a square or rectangular shape may be used for a configuration having a square or rectangular duct. The shape of the coil would then be selected to match the shape and size of the porous elements to allow the heating disks to intersect with high magnetic field region.

In an exemplary embodiment, between induction field coil 12 and discrete inductive heating elements 10, e.g., in the form of porous disks, a conduit tube 7, e.g., made of quartz, is placed to hold and align the heating elements (here, porous disks). Inductive heating elements (e.g., disks) 10 were assembled (here, stacked) on top of a support 6, e.g., also made of quartz, to prevent downward vertical displacement.

The magnetic field generated due to a wire carrying an electric current is described by Biot-Savart equation:

$$B ( r ) = \frac{μ}{4 π} ∮ \frac{Id ℓ \times r}{{\vert r \vert}^{3}} \qquad ( 1 )$$

Therein, B(r) is the resultant magnetic field, dl is the differential element of the wire, I is the electric current, r is the location vector at which the magnetic field is calculated, and μ is the magnetic permeability.

The diameter of the induction field coil 12 is relatively small and, therefore, the density of the magnetic field can be considered diagonally uniform inside the induction coil. This simplifies the calculation of the magnetic field of equation (1) to:

$$B ( r ) = \frac{μ NI}{\sqrt{( 4 {R}^{2} + {l}^{2} )}} , \qquad ( 2 )$$

wherein N is the number of turns, and R and l are the radius and the length of the coil, respectively

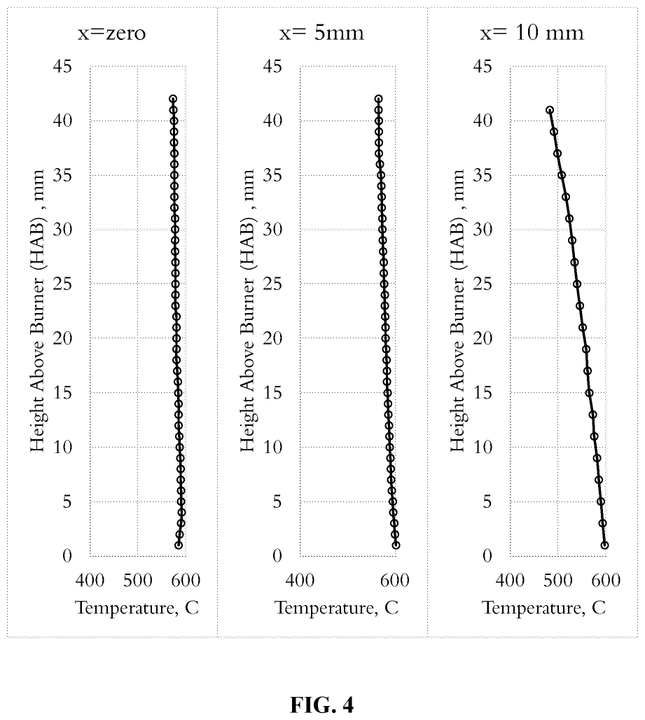

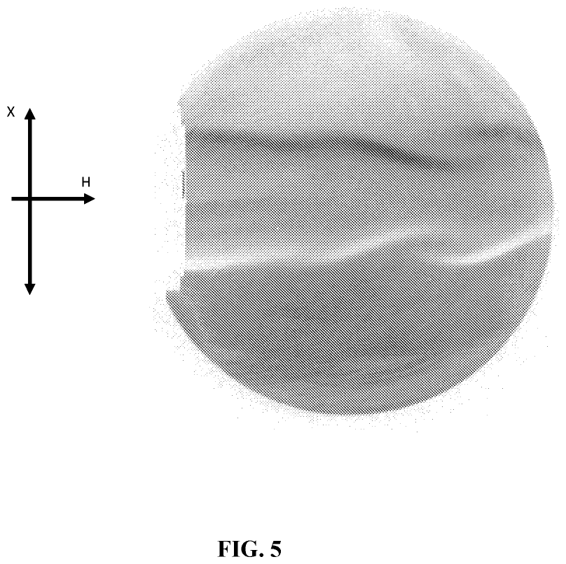

As the porous disks located inside the induction coil, they intersect with the dense magnetic field. Therefore, an eddy current is generated within the disks. Due to the electric resistance, the disks are heated up by Joule heating. When the co-flow air penetrates into and passes through the porous inductive heating elements 10, heat generated therein is transferred to the flow of fluid efficiently due to a large contact area (m²) to volume (m³) ratio of metal foam or other porous material. Air downstream temperature was measured along the axis of the heater and at different radial (X) locations, and the results are shown in FIG. 4, to exhibit extraordinary temperature homogeneity over quite long distances in the H-direction in FIG. 5. In this experiment, the set temperature of air flowing through conduit tube 7 and debouching therefrom at outflow end 15, was set at a value of 600° C. Air in a coflow through conduit tube 7 had a velocity of 0.274 m/s. A carrier gas flow through centre tube 8 carried particles to outflow end of conduit tube 7, for ignition thereof in the airflow from the outflow end 15 of conduit tube 7. The carrier gas was nitrogen and flowed through the centre tube 8 at a velocity of 2.6 m/s. At this set target temperature of 600° C., even at a radial distance of 10 mm (rightmost graph in FIG. 4), a resulting temperature of more than 500° C. was realised up to a height above burner (HAB) of at least approximately 40 mm. At shorter x or r distances, higher temperatures were achieved over a further height above burner (HAB) in a very uniform manner.

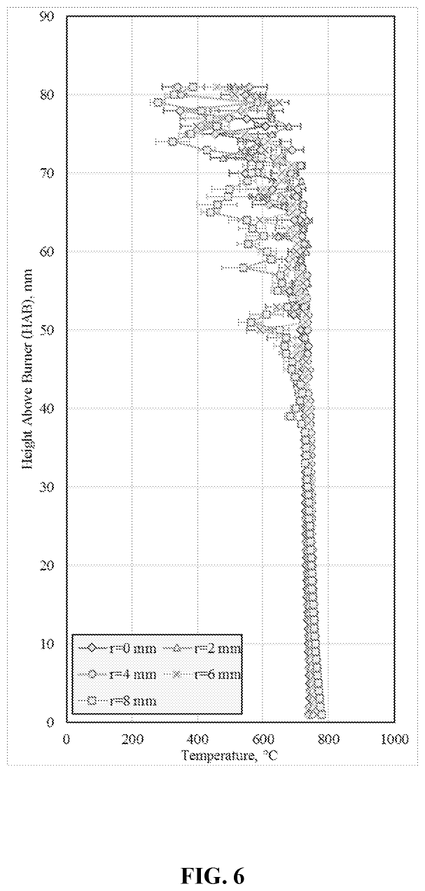

Other experiments were also conducted, and results for one such experiment are shown in FIG. 6. Therein, the temperature of the air in a co-flow was set at 740° C. at 1 mm from the centre tube 8 for supply of a nitrogen flow carrying iron or other metal particles to be ignited in the heated airflow at outflow end 15 of conduit tube 7. Research has confirmed that the same heating system is effective not only for burning iron or other metal particles, but also other types of media, including liquids, oils, waxes, etc. Accordingly, the heating system of the present disclosure can find application in burning liquid waste. This 1 mm point is considered the mesh origin for the co-flow temperature measurements of which the results are set out in FIG. 6. The velocity of the co-flow air through conduit tube 7 was maintained at a value of 0.96 m/s, while the velocity of the particle carrier gas through centre tube 8 was set to a value of 4 m/s. The graph of FIG. 6 sets out temperature measurements at several radii (r) in one view (while FIG. 4 exhibits distinct graphs for individual radial distances x or r) from the mesh origin. Therein, temperature changes are shown at increasing heights above burner (HAB), and it is apparent that up to a height of more than 50 mm above burner (HAB) (so above outflow end 15 of conduit tube 7) at all radii from the mesh origin, a column of heated air with a temperature of at least 600° C. was generated.

FIG. 5 exhibits Schlieren imaging of the temperature homogeneity of fluid in an outbound flow of air as an embodiment of fluid, wherein an original colour Schlieren imaging is converted into a black-and-white image, and subsequently inverted into a photo-negative representation for clarity and ease of reproduction. Also Schlieren imaging for the heater downstream, showing the density gradients contours due to temperature change, confirms that the fluid heating system 1 of the present disclosure enables that a heated fluid flow is generated which has a highly beneficial and desirable temperature homogeneity over long (er) distances from the outflow end of the quartz conduit tube 7.

Experiments like the ones described above with reference to FIGS. 4, 5 and 6, were conducted under confidentiality, and go to show that a heating system including seven disks as in the configuration in FIG. 1 performs well for the heating application for metal particle combustion.

Other numbers of heating elements can also be used in exemplary embodiments, such as two, three, four, five or more than seven, but that may require modification of one or more of other system parameters, such as the thickness of the inductive heating elements 10, the spacing between the inductive heating elements, the length and/or configuration of the field coil, the material of the inductive heating elements, etc. Increasing the number of inductive heating elements (e.g. disks) will distribute the heat over larger area thus possibly decreasing the maximum allowable/attainable temperature. On the other hand, lower number of disks may concentrate heat inside the inductive heating elements. Material properties are a significant factor in selecting the number of inductive heating elements.

The spacing between the porous inductive heating elements 10 in performed experiments was 5 mm, but in other embodiments the spacing can be increased or reduced, for example, increased to about 7 to 20 mm or reduced below 5 mm, for example to 3 mm. Thus, in exemplary embodiments, the spacing between inductive heating elements may be varied between about 3 mm to about 20 mm, and preferably between about 3 mm to about 7 mm.

It is noted here that one possible application of a fluid heating system 1 according to the present disclosure can be burning iron particles, also referred to in the relevant field as iron particle ignition, whereby the heated flow of fluid (e.g. air) of the present disclosure may be deployed for igniting particles, such as metal particles, including but not limited to iron, aluminum, boron, and magnesium. Research has confirmed that the same heating system is effective not only for burning metal particles, but also other types of media, including liquids, oils, waxes, etc. Accordingly the heating system of the present disclosure can find application in burning liquid waste. In view of the ease, with which temperatures of 800° C. and (much) higher may be achieved, the present disclosure allows for applications of iron and other metal particle ignition using the fluid heating system from the present disclosure, as well as other media, including liquids, oils, waxes, etc.

The use of several (porous) discrete inductive heating elements 10 (e.g., disks) within a single conduit 7 and/or a single field generator (including optionally multiple field coils 12 connected to one power source or to a number of coordinated and not independent power sources) for the purpose of heating up fluids is novel and exhibits advantages and functionalities that were logically unforeseeable for the person skilled in the art at the time of a first filing for the present disclosure, and are therefore considered to involve an inventive step.

Although specific embodiments of fluid heating systems according to the present disclosure have been specifically referred to herein, the scope of protection for the fluid heating system is not restricted to these embodiments, but is intended to cover modifications and equivalent arrangements that are within the spirit and scope of the appended claim(s). Any limitation on the scope beyond combined features in the appended claim(s) is unjustified and unwarranted. The scope is not limited to any embodiment(s) described above and shown in the appended figures, but is limited only by the appended claim(s).

1. A fluid heating system, comprising:
a fluid conduit having an inflow end and an outflow end for a flow of fluid to be conducted therethrough;
an inductive heater arranged in the fluid conduit, wherein the flow of fluid passes the inductive heater of which a temperature rises, when subjected to an electromagnetic field; and
an electromagnetic field generator to generate, when activated, the electromagnetic field and thereby induce a rise in temperature of the inductive heater,
wherein the inductive heater comprises a plurality of discrete inductive heating elements.

2. The fluid heating system according to claim 1, wherein at least one of the plurality of inductive heating elements is permeable to the flow of fluid to allow the flow of fluid to pass through the interior thereof.

3. The fluid heating system according to claim 2, wherein at least one of the plurality of inductive heating elements is of a or comprises a structure from a group comprising: porous material, perforated material, mesh, wool, sponge, and foam.

4. The fluid heating system according to claim 1, wherein the plurality of inductive heating elements comprise at least one metal from a group, comprising: cobalt, iron, and nickel.

5. The fluid heating system according to claim 1, wherein the heating elements are arranged one after the other in the flow direction of the flow of fluid.

6. The fluid heating system according to claim 1, wherein at least one pair of immediately adjacent discrete inductive heating elements are arranged at a distance therebetween.

7. The fluid heating system according to claim 6, further comprising at least one spacer arranged between the immediately adjacent heating elements, and/or at least one support configured to hold at least one of the heating elements in the conduit.

8. (canceled)

9. The fluid heating system according to claim 1, wherein at least one of the plurality of inductive heating elements comprises a carrier, wherein heating material, susceptible to heating when subjected to the electromagnetic field, is dispersed therein, wherein the carrier comprises at least one from a group, comprising: a porous material, a foam, a mesh, a perforated material, a wool, and a sponge.

10. (canceled)

11. The fluid heating system according to claim 1, wherein the field generator is arranged outside of the conduit.

12. The fluid heating system according to claim 1, wherein the conduit comprises a thermal insulation.

13. The fluid heating system according to any-preceding claim 1, wherein the fluid conduit comprises a ceramic material, such as alumina or quartz.

14. The fluid heating system according to claim 1, wherein the field generator comprises at least one field coil connected to an AC source.

15. (canceled)

16. The fluid heating system according to claim 14, wherein the AC source comprises a plurality of coordinated or cooperating AC supplies each connected to at least one of a plurality of field coils.

17. The fluid heating system according to claim 1, further comprising an upright, horizontal or angled stand extending at least partially through the fluid conduit to the outflow end of the fluid conduit.

18. The fluid heating system according to claim 17, wherein at least one of the plurality of discrete inductive heating elements has an opening extending therethrough, and the stand is accommodated therein.

19. (canceled)

20. The fluid heating system according to claim 1, wherein at least one and at most all of the plurality of heating elements are disposed within the conduit such that outer peripheries of the plurality of heating element are in close proximity to an inner wall of the conduit.

21. The fluid heating system according to claim 1, wherein none of the plurality of heating elements contacts an inner wall of the conduit.

22. An ignition system, comprising the fluid heating system according to claim 1, a particle supply; and a medium supply.

23. The particle ignition system according to claim 22, wherein the fluid heating system further comprises an upright, horizontal or angled stand extending it least partially through the fluid conduit to the outflow end of the fluid conduit, and wherein the stand comprises a medium delivery tube extending at least partially through the fluid conduit to debouch at or near the outflow end of the fluid conduit.

24. (canceled)

25. (canceled)

26. The ignition system according to claim 22, wherein the fluid heating system further comprises a medium delivery assembly comprising a tubular medium delivery channel extending at least partially through the fluid conduit to debouch at or near the outflow end of the fluid conduit, wherein the medium delivery assembly has an inlet and an outlet connected to the inlet by the medium delivery channel, the inlet of the medium delivery assembly being in fluid communication with the medium generator.

27-29. (canceled)
